(19) United States
(12) Patent Application Publication
(10) Pub. No.: US 2014/0084129 A1
(43) Pub. Date: Mar. 27, 2014

(54) ASSEMBLY FOR MOUNTING A TURBINE ENGINE CASE TO A PYLON

(71) Applicant: David F. Sandy, Milford, CT (US)

(72) Inventor: David F. Sandy, Milford, CT (US)

(73) Assignee: United Technologies Corporation, Hartford, CT (US)

(21) Appl. No.: 13/629,012

(22) Filed: Sep. 27, 2012

(51) Int. Cl. B64D 27/00

(52) U.S. Cl. 248/554

(57) ABSTRACT

An assembly for mounting a turbine engine case to a pylon. The assembly includes a beam and a shackle. The shackle includes a plurality of side segments, and an intermediate segment that is engaged rotatably to the beam. Each of the side segments has a fastener aperture and a slot. The fastener aperture extends through the respective side segment. The slot extends laterally into the respective side segment.

### BACKGROUND OF THE INVENTION

1. Technical Field

The present invention relates generally to a turbine engine system and, more particularly, to an assembly for mounting a turbine engine case to a pylon.

2. Background Information

Various assemblies are known in the art for mounting a turbine engine case to a pylon, which may connect the case to an aircraft wing. One such mounting assembly includes a beam that connects to a forward portion of the pylon. This mounting assembly also includes a shackle that connects the beam to mounting lugs located at a forward end of the case. The shackle may extend into a slot formed between the mounting lugs, and is connected to the mounting lugs with a plurality of fasteners.

During normal operation, the fasteners transfer loads between the mounting lugs and the shackle in double shear. The fasteners, for example, are subjected to shear forces by the mounting lugs on both sides of the shackle. If a first of the mounting lugs fails, however, the fasteners transfer the loads between a second of the mounting lugs and the shackle in single shear. The fasteners, for example, are subject to shear forces by the second mounting lug on a single side of the shackle. This load eccentricity between the second mounting lug and the shackle may subject the fasteners to a bending moment, which may increase stresses within the mounting lug, the shackle and the fasteners.

### SUMMARY OF THE DISCLOSURE

According to an aspect of the invention, an assembly is provided for mounting a turbine engine case to a pylon. The assembly includes a beam and a shackle. The shackle includes a plurality of side segments, and an intermediate segment that is engaged rotatably to the beam. Each of the side segments has a fastener aperture and a slot. The fastener aperture extends through the respective side segment. The slot extends laterally into the respective side segment.

According to another aspect of the invention, an assembly is provided for mounting to a pylon. The assembly includes a turbine engine case, a beam, a shackle, a case attachment, and a plurality of fasteners. The shackle includes a plurality of side segments, and an intermediate segment that is engaged rotatably to the beam. Each of the side segments has a slot that communicates laterally into the respective side segment. The case attachment is connected to the case, and extends into the slot. The fasteners respectively connect the side segments to the case attachment.

According to still another aspect of the invention, an assembly is provided for mounting to a turbine engine case. The assembly includes a pylon, a beam, and a shackle. The pylon extends axially between a forward pylon end and an aft pylon end. The beam is connected to the pylon at the forward pylon end. The shackle includes a plurality of side segments, and an intermediate segment that is engaged rotatably to the beam. Each of the side segments has a fastener aperture and a slot. The fastener aperture extends through the respective side segment. The slot extends laterally into the respective side segment.

The shackle may include a first plate and a second plate.

The first plate may be arranged parallel to the second plate.

The first plate may be stacked upon the second plate.

The fastener apertures may extend axially through the first and the second plates.

The slots may be defined between the first and second plates.

The slot in each of the side segments may communicate laterally into the first plate. Each of the side segments may have a second slot that communicates laterally into the second plate. The slots may be respectively arranged parallel to the second slots. The case attachment may extend into the second slots.

The assembly may include a linkage that includes a first thrust link and a second thrust link. The beam may include a flange that is connected to the linkage and arranged laterally between the first and the second thrust links.

The linkage may include a whiffletree beam that connects the first and the second thrust links to the flange.

The case attachment may include an intermediate lug arranged axially between a first end lug and a second end lug. The intermediate lug may extend radially into the slot. The first plate may extend radially into a slot defined between the first end lug and the intermediate lug. The second plate may extend radially into a slot defined between the second end lug and the intermediate lug.

The case attachment may include a first lug and a second lug. The first lug may extend radially into the slot, and the second lug may extend radially into the second slot. Adjacent portions of the first and the second plates may extend radially into a slot that is defined between the first and the second lugs.

One of the fasteners may include a pin and a bolt, where the bolt is concentric with and extends through the pin.

The assembly may also include a linkage and a pair of second case attachments. The linkage may include a first thrust link and a second thrust link. The second case attachments may be respectively connected to the first and the second thrust links. The beam may include a flange that is connected to the linkage and arranged laterally between the first and the second thrust links.

The foregoing features and the operation of the invention will become more apparent in light of the following description and the accompanying drawings.

### BRIEF DESCRIPTION OF THE DRAWINGS

FIG. 1 is a side illustration of an assembly for mounting a turbine engine case to a pylon;

FIG. 2 is a side-sectional illustration of a forward mounting assembly;

FIG. 3 is a front illustration of the forward mounting assembly of FIG. 2;

FIG. 4 is a rear illustration of the forward mounting assembly of FIG. 2;

FIG. 5 is a side-sectional illustration of a shackle interlocked with and connected to a case attachment;

FIG. 6A is a sectional illustration of the shackle and the case attachment of FIG. 5 during a normal mode of operation;

FIG. 6B is a sectional illustration of the shackle and the case attachment of FIG. 5 during a failure mode of operation;

FIG. 6C is a sectional illustration of the shackle and the case attachment of FIG. 5 during another failure mode of operation; and

FIG. 7 is a sectional illustration of an alternate embodiment shackle interlocked with and connected to alternate embodiment case attachment.

### DETAILED DESCRIPTION OF THE INVENTION

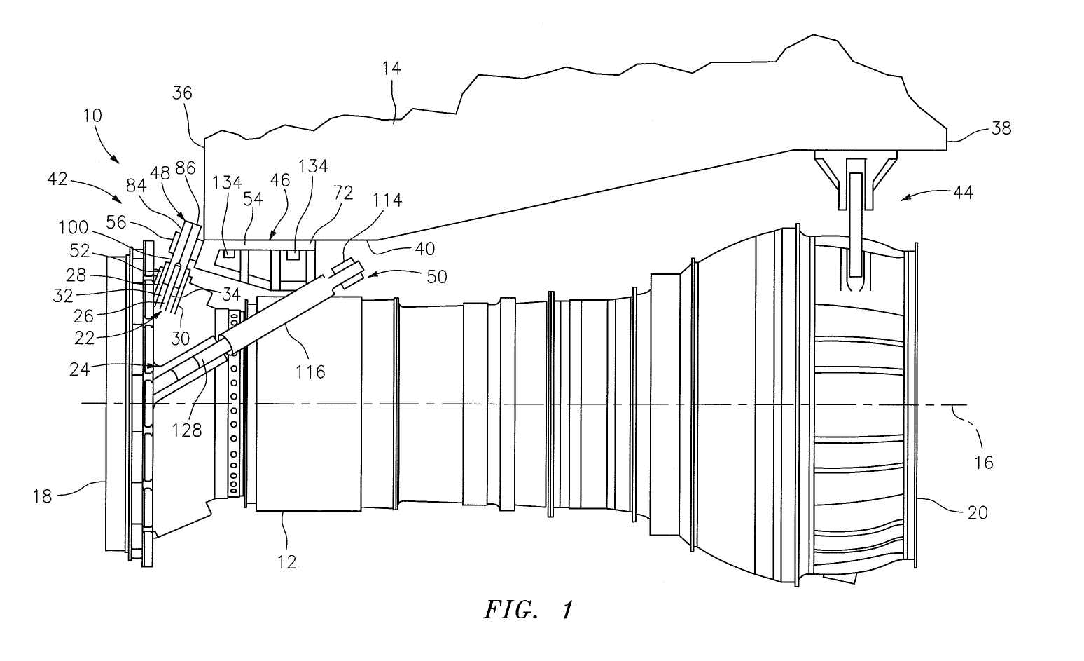

FIG. 1 illustrates a mounting assembly 10 for mounting a turbine engine case 12 to a pylon 14. The case 12 houses at least a portion of one or more turbine engine sections such as, for example, a compressor section, a combustor section and a turbine section. The case 12 extends along an axial centerline 16 between a first (e.g., forward) case end 18 and a second (e.g., aft) case end 20.

The pylon 14 extends axially along the centerline 16 between a first (e.g., forward) pylon end 36 and a second (e.g., aft) pylon end 38. The pylon 14 extends radially out from an inner pylon end 40 to an outer pylon end (not shown), which may be connected to a portion of an aircraft airframe such as, for example, an aircraft wing or an aircraft fuselage.

The mounting assembly 10 is adapted to connect the case 12 to the pylon 14. The mounting assembly 10 includes, for example, one or more sub-assemblies such as a first (e.g., forward) mounting assembly 42 and a second (e.g., aft) mounting assembly 44. The first mounting assembly 42 connects the case 12 at (e.g., adjacent or proximate to) the first case end 18 to the pylon 14 at the first pylon end 36, and is described below in further detail. The second mounting assembly 44 connects the case 12 at the second case end 20 to the pylon 14 at the second pylon end 38. Various second mounting assembly configurations are known in the art and therefore are not described in further detail.

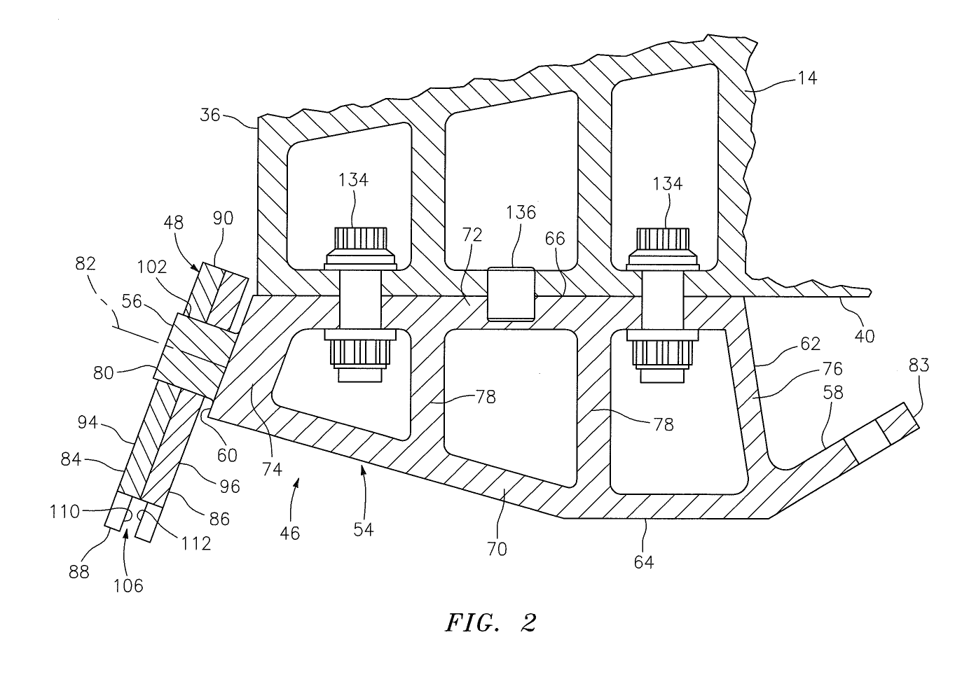

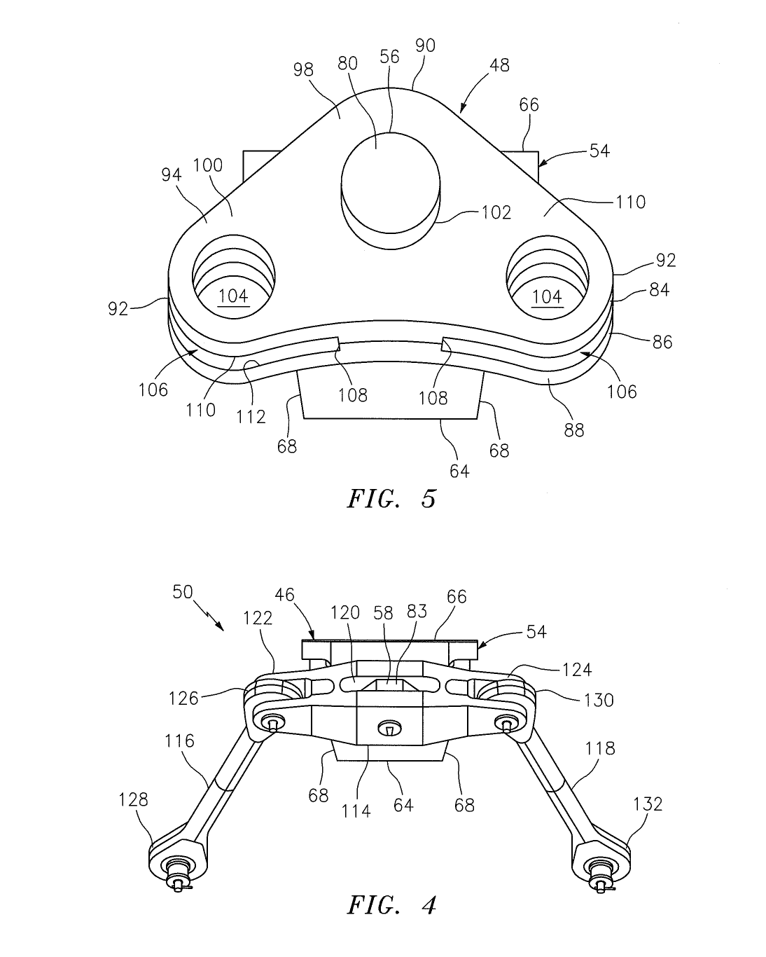

The mounting assembly 42 includes a cantilevered beam 46, a shackle 48, a linkage 50 (e.g., a whiffletree), a first case attachment 22, a pair of second case attachments 24, and a plurality of fasteners 52. Referring to FIG. 2, the beam 46 includes a support structure 54, a projecting pin 56 and a flange 58. The support structure 54 extends axially between a first (e.g., forward) end 60 and a second (e.g., aft) end 62. The support structure 54 extends radially between a radial inner end 64 and a radial outer end 66. Referring to FIGS. 3 and 4, the support structure 54 extends laterally (e.g., circumferentially or tangentially) between opposing sides 68.

Referring again to FIG. 2, the support structure 54 may be configured as a webbed shear resistant beam in order to provide structural rigidity while reducing support structure 54 mass and weight. The support structure 54 embodiment of FIG. 2, for example, includes a radial inner cap 70, a radial outer cap 72, a first (e.g., forward) end cap 74, and a second (e.g., aft) end cap 76. The inner cap 70 is located adjacent the inner end 64, and the outer cap 72 is located adjacent the outer end 66. The inner and the outer caps 70 and 72 may each extend axially between and be radially separated by the first and the second end caps 74 and 76. The first end cap 74 is located adjacent to the first end 60, and the second end cap 76 is located adjacent to the second end 62. At least one rib 78 may also extend radially between the inner and the outer caps 70 and 72 to provide additional structural rigidity.

The pin 56 extends axially out from the first end 60 or cap 74 to a distal end 80. The pin 56 has a centerline 82 that may be angularly offset from the centerline 16 (see FIG. 1) by, for example, between about fifteen and twenty degrees (e.g., about 19°). In the embodiment of FIG. 3, the pin 56 is configured as a cylindrical protrusion to enable the shackle 48 to pivot about the centerline 82.

Referring to FIGS. 2 and 4, the flange 58 extends axially out from the second end 62 to a distal flange end 83. The flange 58 may be angularly offset from the centerline 16 (see FIG. 1) by, for example, about thirty degrees.

Referring again to FIGS. 2 and 3, the shackle 48 is configured from a stack of discrete, parallel plates 84 and 86. The plates 84 and 86 may be face-to-face, and extend radially between a radial inner end 88 and a radial outer end 90. The plates 84 and 86 extend laterally between opposing sides 92. The shackle 48 spans axially between a surface 94 of the first plate 84 and an opposite surface 96 of the second plate 86.

The shackle 48 includes an intermediate segment 98 arranged laterally between a pair of side segments or wings 100. The intermediate segment 98 includes an aperture 102 that extends axially through the plates 84, 86 of the shackle 48. The aperture 102 may be centered laterally between the sides 92, and located proximate the outer end 90. Each of the side segments 100 extends between the intermediate segment 98 and the respective sides 92 and the inner end 88. Each of the side segments 100 may have a fastener aperture or hole 104 and a slot 106. The aperture 104 communicates axially through both plates 84, 86 of the shackle 48, and may be located proximate respective sides 92 and the inner end 88. The slot 106 extends laterally into the shackle 48 from a respective side 92 and the inner end 88 to a slot end or bottom 108. In the shackle 48 embodiment of FIGS. 2 and 3, the slot 106 is defined between a surface 110 carried by the first plate 84 and an opposing surface 112 carried by the second plate 86. The slot 106 communicates with and through the respective apertures 104.

Referring to FIGS. 1 and 4, the linkage 50 of mounting assembly 42 may include a whiffletree beam 114 connected laterally between a first thrust link 116 and a second thrust link 118. The whiffletree beam 114 embodiment of FIG. 4 includes a mounting aperture 120 arranged laterally between a first forked end 122 and a second forked end 124. The mounting aperture 120 extends axially through the whiffletree beam 114. The first thrust link 116 may be configured as a strut that extends between a pair of Heim joints 126 and 128, a first 126 of which is connected to the first forked end 122 with a fastener. The second thrust link 118 may also be configured as a strut that extends between a pair of Heim joints 130 and 132, a first 130 of which is connected to the second forked end 124 with a fastener.

Referring to FIG. 1, the first case attachment 22 and the second case attachments 24 are connected to (e.g., mechanically fastened to, formed integral with, etc.) the case 12. The first case attachment 22 is arranged circumferentially between the second case attachments 24. The first and the second case attachments 22 and 24 may be axially located proximate the first case end 18. The first and the second case attachments 22 and 24 may each include one or more (e.g., parallel) mounting lugs. In the embodiment of FIG. 1, for example, the first case attachment includes an intermediate lug 26 arranged axially between a pair of end lugs 28 and 30. A first attachment slot 32 is defined and extends axially between the mounting lugs 26 and 28. A second attachment slot 34 is defined and extends axially between the mounting lugs 26 and 30.

Referring to FIGS. 1 and 2, the support structure 54 is connected to the pylon 14 at the first pylon end 36. The outer cap 72, for example, is mechanically fastened to a radial inner plate of the pylon 14 with a plurality of fasteners 134 and 136 (e.g., bolts and/or pins).

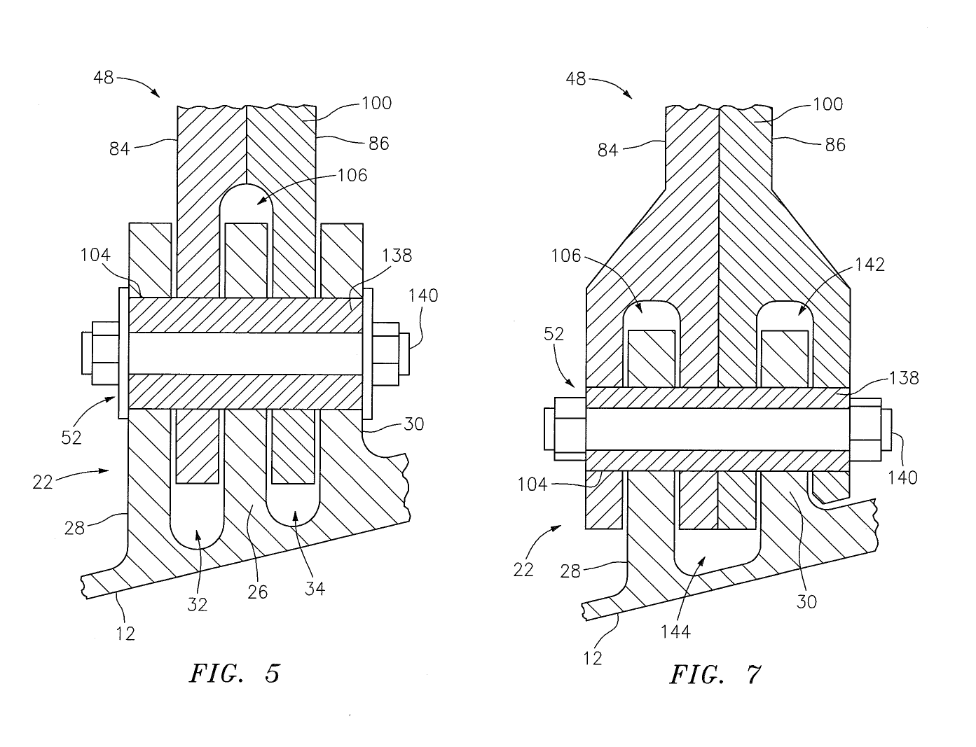

The shackle 48 is pivotally connected to the beam 46 and, in particular, the pin 56 extends into the aperture 102. The side segments 100 of the shackle 48 are interlocked with and connected to the first case attachment 22. For example, referring to FIG. 5, the intermediate lug 26 extends radially into the slot 106 between the first and the second plates 84 and 86. The first plate 84 extends into the slot 32 between the first end lug 28 and the intermediate lug 26. The second plate 86 extends into the slot 34 between the intermediate lug 26 and the second end lug 30. The fasteners 52 connect the respective side segments 100 of the shackle 48 to the first case attachment 22 of the case 12.

Referring to FIGS. 1 and 4, the flange 58 extends into the aperture 120. A fastener extends through the whiffletree beam 114 and the flange 58 to pivotally connect the linkage 50 to the beam 46. A plurality of fasteners respectively extend through the second case attachments 24 and are respectively mated with the second Heim joint ends 128 and 132 to connect the linkage 50 to the case 12.

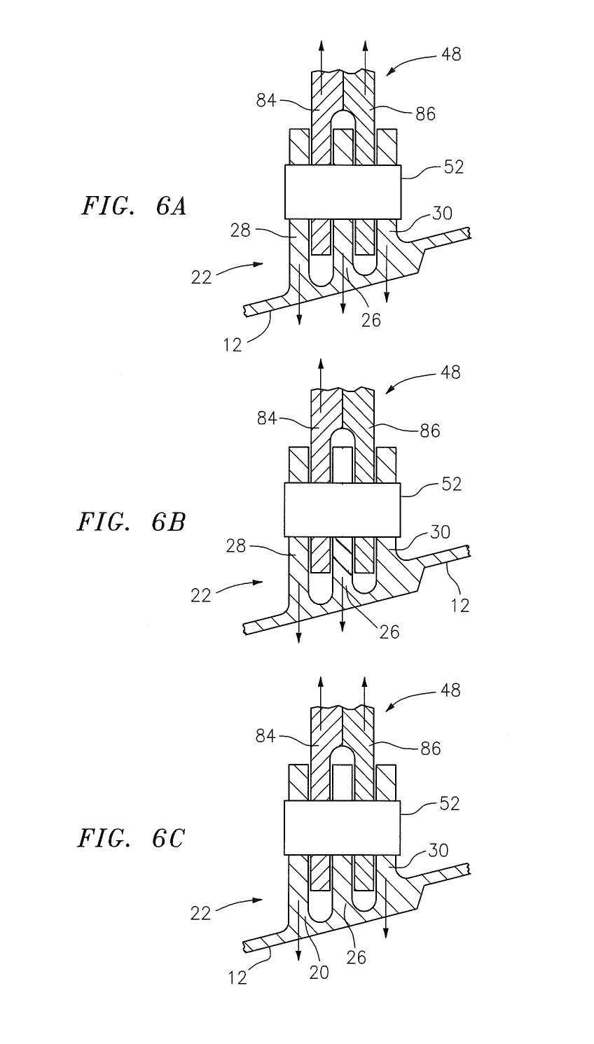

Referring to FIG. 1, the first assembly 42 may transfer axial, radial and/or lateral loads between the case 12 and the pylon 14 during aircraft operation. Referring specifically to the interface of FIG. 5, each of the fasteners 52 may transfer radial and axial loads between the first case attachment 22 and the shackle 48 through shear. Referring to FIG. 6A, for example, the fasteners 52 may transfer a first portion of the loads between the lugs 26 and 28 and the first plate 84 through double shear. The fasteners 52 may also transfer a second portion of the loads between the lugs 26 and 30 and the second plate 86 through double shear. The interlocking configuration of the first case attachment 22 and the shackle 48 also enables the fasteners 52 to maintain this double shear load transfer during some failure modes of operation. Referring to FIG. 6B, for example, the fasteners 52 may transfer the first and the second portions of the loads between the lugs 26 and 28 and the first plate 84 through double shear where the second end lug 30 and/or the second plate 86 fails. In another example, referring to FIG. 6C, the fasteners 52 may transfer the first and the second portions of the loads between the lugs 28 and 30 and the first and the second plates 84 and 86 through double shear where the intermediate lug fails. The interlocking configuration of the first case attachment 22 and the shackle 48 therefore may reduce or eliminate load eccentricity during some failure modes of operation, which may reduce stresses within the first case attachment 22, the shackle 48 and/or the fasteners 52.

In some embodiments, for example as illustrated in FIG. 5, one or more of the fasteners 52 may each include a pin 138 and a bolt 140. The bolt 140 may be concentric with and extend through the pin 138. In other embodiments, one or more of the fasteners 52 may each be configured as a pin or a bolt. The present disclosure, of course, is not limited to any particular fastener embodiments.

In some embodiments, for example as illustrated in FIG. 7, each of the side segments 100 of the shackle 48 may include a shackle second slot 142. In contrast to the embodiment of FIG. 5, the slot 106 communicates (e.g., extends) laterally into the first plate 84 and the second slot 142 communicates laterally into the second plate 86. In addition, the intermediate lug 26 may be omitted from this embodiment. The first end lug 28 extends radially into the slot 106, and the second end lug 30 extends radially into the second slot 142. Adjacent portions of the first and the second plates 84 and 86 extend radially into a slot 144 formed axially between the first and the second end lugs 28 and 30. The fasteners 52 connect the respective side segments 100 of the shackle 48 to first case attachment 22 of the case 12.

In some embodiments, the beam 46 may be constructed as a single unitary body as illustrated, for example, in FIGS. 2 to 4. In other embodiments, the beam 46 may be constructed from a plurality of segments; e.g., two halves.

In some embodiments, the shackle may also include a plurality of spherical bearings. The bearings are respectively mated with the fastener apertures, and enable the fasteners to pivot relative to the shackle.

A person of skill in the art will recognize the beam, the linkage, and/or one or more of the fasteners may have alternative configurations to those described above and illustrated in the drawings depending, for example, upon the loads transferred between the turbine engine case and the pylon and/or other design constraints. The present invention therefore is not limited to any particular beam, linkage, and/or fastener configurations.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

What is claimed is:

1. An assembly for mounting a turbine engine case to a pylon, comprising:
a beam; and
a shackle including an intermediate segment engaged rotatably to the beam, and a plurality of side segments, wherein each of the side segments has a fastener aperture and a slot, the fastener aperture extends through the respective side segment, and the slot extends laterally into the respective side segment.

2. The assembly of claim 1, wherein the shackle comprises a first plate and a second plate.

3. The assembly of claim 2, wherein the first plate is arranged parallel to the second plate.

4. The assembly of claim 2, wherein the fastener apertures extend axially through the first and the second plates.

5. The assembly of claim 2, wherein the slots are defined between the first and second plates.

6. The assembly of claim 2, wherein the slot in each of the side segments communicates laterally into the first plate, and each of the side segments further has a second slot that communicates laterally into the second plate.

7. The assembly of claim 6, wherein the slots are respectively arranged parallel to the second slots.

8. The assembly of claim 1, further comprising:
a linkage that includes a first link and a second link;
wherein the beam further includes a flange connected to the linkage and arranged laterally between the first and the second links.

9. The assembly of claim 8, wherein the linkage further includes a whiffletree beam that connects the first and the second links to the flange.

10. An assembly for mounting to a pylon, comprising:
a turbine engine case;
a beam;
a shackle including an intermediate segment engaged rotatably to the beam, and a plurality of side segments, wherein each of the side segments has a slot that communicates laterally into the respective side segment;
a case attachment connected to the case, wherein the case attachment extends into the slot; and
a plurality of fasteners that respectively connect the side segments to the case attachment.

11. The assembly of claim 10, wherein the shackle has a first plate stacked upon a second plate.

12. The assembly of claim 11, wherein the slots are defined between the first and the second plates.

13. The assembly of claim 12, wherein
the case attachment includes an intermediate lug arranged axially between a first end lug and a second end lug, and the intermediate lug extends radially into the slot;
the first plate extends radially into a slot defined between the first end lug and the intermediate lug; and
the second plate extends radially into a slot defined between the second end lug and the intermediate lug.

14. The assembly of claim 11, wherein
the slot in each of the side segments communicates laterally into the first plate;
each of the side segments further has a second slot that communicates laterally into the second plate; and
the case attachment extends into the second slots.

15. The assembly of claim 14, wherein
the case attachment includes a first lug and a second lug, the first lug extends radially into the slot, and the second lug extends radially into the second slot; and
adjacent portions of the first and the second plates extend radially into a slot defined between the first and the second lugs.

16. The assembly of claim 10, wherein one of the fasteners includes a pin and a bolt, and the bolt is concentric with and extends through the pin.

17. The assembly of claim 10, further comprising:
a linkage that includes a first thrust link and a second thrust link; and
a pair of second case attachments that are respectively connected to the first and the second thrust links;
wherein the beam further includes a flange that is connected to the linkage and arranged laterally between the first and the second thrust links.

18. An assembly for mounting to a turbine engine case, comprising:
a pylon;
a beam connected to the pylon; and
a shackle including an intermediate segment engaged rotatably to the beam, and a plurality of side segments, wherein each of the side segments has a fastener aperture and a slot, the fastener aperture extends through the respective side segment, and the slot extends laterally into the respective side segment;
wherein the shackle comprises a first plate and a second plate.

19. The assembly of claim 18, wherein the slots are defined between the first and the second plates.

20. The assembly of claim 18, wherein
the slot in each of the side segments communicates laterally into the first plate; and
each of the side segments further has a second slot that communicates laterally into the second plate.
